(19) United States
(12) Patent Application Publication
(10) Pub. No.: US 2024/0400813 A1
(43) Pub. Date: Dec. 5, 2024

(54) STABLE RESIN METHODS AND COMPOSITIONS FOR AQUEOUS TREATMENTS

(71) Applicant: QUAKER CHEMICAL CORPORATION, Wilmington, DE (US)

(72) Inventors: Ricardo NUNEZ, Philadelphia, PA (US); Linfeng GOU, Chesterbrook, PA (US); Junren LIN, King of Prussia, PA (US); Matthew D. LOCOCO, Centerville, OH (US); Chad JOHNSON, Granville, OH (US); Stephanie WILLIAMSON, Reading, PA (US)

(73) Assignee: QUAKER CHEMICAL CORPORATION, Wilmington, DE (US)

(21) Appl. No.: 18/695,115

(22) PCT Filed: Sep. 27, 2022
(86) PCT No.: PCT/US2022/077085

§ 371 Date: Mar. 25, 2024

Related U.S. Application Data
(60) Provisional application No. 63/248,792, filed on Sep. 27, 2021.

(51) Int. Cl. C08L 33/08

(52) U.S. Cl. CPC C08L 33/08

(57) ABSTRACT

Methods and compositions for stabilized, emulsified aqueous resin and/or polymer emulsions within aqueous fluids characterized by extreme chemical environment having high ionic strengths and/or extremes of pH are provided. The methods include combining an organic premix comprising an aqueous fluid and the emulsified aqueous resin/emulsion polymers with a high hydrophobic-lipophilic balance (HLB) surfactant and a fluid having an extreme chemical environment (e.g., an acidic passivate) to yield a composition wherein the emulsified aqueous resins are stabilized. Other methods include combining an emulsified aqueous resin/emulsion polymer with a high hydrophobic-lipophilic balance (HLB) surfactant and a fluid having an extreme chemical environment (e.g., an acidic passivate) to yield a composition wherein the emulsified aqueous resins are stabilized.

### BACKGROUND OF THE INVENTION

The present invention generally relates to resin and/or emulsion polymer compositions and, more particularly, to methods of producing stable aqueous resin and/or emulsion polymer compositions in extreme chemical environments characterized by high/low pH and/or high ionic strength.

Commercial specialty coatings and industrial fluids may employ a vast array of resins as additives. For example, industrial coatings for different substrates include resins helpful in preventing undesirable states such as corrosion or abrasion in metal working applications.

Many of the commercial polymers found most useful as additives for industrial coatings are insoluble in water. As many industrial coatings and fluids are water-based, these polymers are manufactured as “resins” using emulsion and dispersion technology to adequately incorporate them within aqueous industrial fluids and coatings.

Many existing resins useful for imparting favorable physical properties (e.g., resistant to abrasion, water repellency, pot life extension, resistance to syneresis, high film strength, high adhesion, and self-healing/anti-corrosive properties), particularly those useful in metal working, are stable in aqueous environments not characterized by high/low pH and/or by high ionic strength as a result of existing emulsion and dispersion technology. These resins, however, are often not stable in fluids having “extreme” chemical environments characterized by high or low pH and/or by high ionic strength. These resins/emulsion polymers may be characterized as those with polymeric syntheses that yield unstable chemical formulas within the “extreme” chemical environments.

Another way to characterize these particular resins/emulsion polymers is by critical coagulation concentration (“CCC”); this is the concentration of ions present within aqueous fluids at which a particular resin or emulsion polymer coagulates or destabilizes. CCC levels close to 0 indicate that a resin is easily destabilized, while high CCC levels amongst resins/emulsion polymers are rare. Typically “unstable” resins and/or emulsion polymers have polymeric syntheses that yield low CCC levels (i.e., resins that are easily destabilized in the “extreme” environments set forth herein). In particular, combining high/low pH and or high ionic strength fluids with these typical “unstable” resins/emulsion polymers (i.e., those considered in the art to not maintain stability in fluids having high/low pH and/or high ionic strength) is generally unsuccessful and results in either immediate emulsion destabilization and/or gelling of the fluid over time.

Unfortunately, many coating compositions and industrial fluids in which these “unstable” resins would be useful have “extreme” chemical environments-those characterized by high ionic strength and/or very low or very high pH. Accordingly, many existing resins useful for imparting desirable properties, while stable in neutral or near-neutral aqueous environments as a result of surfactant-enabled emulsion and dispersion technology, are not stable in industrial fluids having “extreme” chemical environments characterized by high or low pH and/or by high ionic strength (e.g., passivation fluids). Thus, while these resins would be beneficial to include in industrial fluids and coatings, the “extreme” chemical environments of such fluids and coatings make incorporating and maintaining emulsions, dispersions, and/or colloids of these resins difficult for formulators.

In response to these difficulties, there have been efforts to develop methods to stabilize resins within extreme chemical environments. For example, rather than attempt to stabilize existing resins known for their efficacy in imparting useful properties (e.g., anti-corrosion or anti-abrasion characteristics), formulators may attempt to completely alter the chemical makeup of commercial polymers and resins altogether to yield modified synthetic resins/polymer emulsions inherently stable in high/low pH and/or high ionic strength fluids. These resins are understood to have undergone a fundamental chemical change (either during or after synthesis) to establish their stability in extreme environments. Such attempts often involve complex polymerization processes involving numerous components (including polymeric stabilizers), high temperatures, and specialty reaction equipment. Notably, such processes are impractical in terms of costs and time for many formulators to carry out to achieve stability of industrial fluids and coatings having resin additives. In addition, many industrial plants are not equipped with the necessary reaction vessels to carry out synthesis of these modified resins. These complex and costly “re-formulation” or “modification” processes are therefore highly difficult or impossible to carry out for many formulators.

Resins and emulsion polymers may also be “re-formulated” or “modified” after synthesis by addition of reactive surfactants; i.e., surfactants that react with resins and/or emulsion polymers such that the chemical formula of the surfactants change. The “reactive” surfactants may form covalent bonds with the resins and emulsion polymers to form “re-formulated” or “modified” resins.

Additionally, these “re-formulated” or “modified” resin additives, while naturally stable in the “extreme” chemical environments present in industrial fluids and coatings, are generally chemically altered such that desirable properties (e.g., anti-corrosion or anti-abrasion properties), may be changed or less effective than those present in typically “unstable” resins (i.e., those which until the inventive systems and processes herein, were not stable in fluids having high/low pH and/or high ionic strength). That is, re-formulating resins at a fundamental chemical level changes their properties such that they are often less desirable as industrial fluid and coating additives.

It would therefore be helpful to have simple methods of stabilizing typically “unstable” resins that are aqueous and intolerant to “extreme” environments within various industrial fluids and coatings. Moreover, it would be helpful if formulators can carry out these methods easily without needing complex materials, polymerization processes, or “reactive” surfactants to produce new resins inherently stable within “extreme” environments. Additionally, it would be desirable to have a universal stabilization process for “extreme” chemical environments that can be carried out using easily accessible and commercially available materials and resins. Surprisingly, the inventors of the present systems and processes were able to stabilize typically “unstable” resins with proven beneficial properties in “extreme” chemical environments without fundamentally altering the chemistry of the resins/emulsion polymers themselves. Thus, the inventors have discovered and implemented inventive systems and processes that eliminate the need to develop new synthetic resins inherently stable in “extreme” environments, thereby reducing both time and financial costs and yielding industrial fluids with additives having known efficacious and desirable properties.

### BRIEF SUMMARY OF THE INVENTION

In one embodiment there is a method of stabilizing emulsified aqueous resins within an aqueous fluid characterized by an extreme chemical environment having a high ionic strength and/or high/low pH. The method includes combining an aqueous resin/emulsion polymer or an organic premix comprising the aqueous fluid and the aqueous resin(s)/emulsion polymer(s) with a high hydrophobic-lipophilic balance (HLB) surfactant and an industrial fluid or coating having an “extreme” chemical environment (e.g., an acidic passivate fluid) to yield a composition wherein the emulsified aqueous resins are stabilized despite the “extreme” chemical environment of the industrial fluid or coating. The emulsified aqueous resins may be or comprise emulsion polymers. The resultant composition may comprise from about 0.5 wt % to about 50 wt % aqueous resins.

In some embodiments of the method, the high ionic strength of the extreme chemical environment of the industrial fluid or coating (e.g., acidic passivation fluid) is characterized by an ionic strength capable of destabilizing the resin or emulsion polymer as manufactured; i.e., the ionic strength of the industrial fluid or coating would otherwise destabilize the resin or emulsion polymer of choice without, for example, the techniques of the methods disclosed herein. That is, an “extreme chemical environment” is one that is defined by the stability characteristics of the resins and/or emulsion polymer(s) desired to be used in formulations. Additionally, an “extreme chemical environment” may be characterized by a pH that destabilizes the resin/polymer emulsion system of choice. In general, the extreme chemical environment may be alternatively or further characterized by a pH of lower than about 3 or greater than about 11. The aqueous fluid characterized by an extreme chemical environment having a high ionic strength comprises any class of electrolytes present in solution that destabilize the resin/emulsion polymer system. In general, strong electrolytes are useful in some industrial fluid or coating formulations, but lower the stability of emulsions. These electrolytes include, but are not limited to, nitrates, phosphates, sulfates, chlorates, and combinations thereof. In other embodiments, the high ionic strength of the extreme chemical environment of the industrial fluid or coating is characterized by any ionic strength that destabilizes a combination of various resins/emulsion polymers used in a formulation.

A resin/emulsion polymer as described herein can refer to any single resin or emulsion polymer typically destabilized in “extreme” chemical environments, or any combination thereof, as used in any formulations in accordance with the methods presented herein.

In some embodiments of the method, an organic premix comprising the resin(s)/emulsion polymer(s) of choice and an aqueous fluid is provided. The aqueous fluid of the organic premix may include an industrial fluid or coating composition. The aqueous fluid of the organic premix may comprise any individual or combination of resin, polymers, surfactant stabilizer, wax, wetting aids, defoamers, fillers, rheology modifiers, film forming agents, and any other additives useful for the industrial application of choice.

In some embodiments of the method, the organic premix comprising the aqueous fluid and the aqueous resins is combined with a high hydrophobic-lipophilic balance (HLB) surfactant and an additional industrial fluid or coating having an “extreme” chemical environment (e.g., an acidic passivate fluid). A high HLB surfactant includes one or more of the nonionic class of ethoxylate surfactants in the range of HLB 8 or higher. The resultant compositions may include from about 0.1 wt % to about 15 wt % high HLB surfactant. The amount of high HLB surfactant may be increased as the ionic strength of the aqueous fluid increases to maintain stability of the emulsified aqueous resin systems of the organic premix.

In another embodiment of the invention, a method of stabilizing emulsified aqueous resins/polymers within an aqueous fluid characterized by an extreme chemical environment having a high ionic strength and/or high/low pH is provided. The method includes combining aqueous resin(s) and/or aqueous emulsion polymer(s) with a high hydrophobic-lipophilic balance (HLB) surfactant and an industrial fluid or coating having an “extreme” chemical environment (e.g., an acidic passivate fluid) to yield a composition wherein the aqueous resin(s) and/or emulsion polymers are stabilized despite the “extreme” chemical environment of the aqueous fluid. The emulsified aqueous resins may be or comprise emulsion polymers. The resultant composition may comprise from about 0.5 wt % to about 50 wt % aqueous resins.

In some embodiments of the method, the aqueous fluid characterized by an “extreme” chemical environment is a passivation fluid. A passivation fluid, or passivate, includes one or more of a passivating species, or combination of species, able to react with a metal surface, or able to incorporate into a film on a metal surface, to offer benefits in corrosion resistance. The passivating species may include a Cr source, such as Cr(VI) Oxide, Cr(III) Nitrate, Cr(III) Phosphate, a combination of these, or any other metal used to improve corrosion resistance. Other additives may be added to this passivate, such as reducing agents, waxes, defoamers, and any other additives useful for the industrial application of choice.

These passivates may further be strongly acidic in nature, which may be useful for the industrial application of choice. The strong acids include, but are not limited to, common mineral acids such as nitric acid (HNO₃), phosphoric acid (H₃PO₄), and HEDP/etidronic acid (C₂H₈O₇P₂). The strong acids may include both organic and inorganic acids. Thus, the fluid having an “extreme” chemical environment may be an acidic passivate. The acidic passivate may include other additives, such as reducing agents, waxes, defoamers, and any other additives useful for the industrial application of choice.

In some embodiments of the method, the aqueous resins/emulsion polymers are stabilized in the extreme environment, wherein stability can be assessed through accelerated testing or ambient testing. An aqueous resin/emulsion polymer is considered “stable” in the system if it retains its properties in a flowing liquid state for at least 2 years sealed at ambient conditions or for at least 30 days in accelerated testing at extreme temperatures. Accelerated testing at extreme temperatures includes both high and low temperature protocols. High-temperature accelerated testing is accomplished by exposing the resin system in a sealed oven/heated environment at 60° C. for 1 month (30 days) and assessing the resin/emulsion polymer system continuously for changes in consistency, gelling, or deterioration in properties. Low-temperature accelerated testing is accomplished by exposing the resin/emulsion polymer system in a sealed refrigeration system at 5° C. for 1 month (30 days) and assessing the resin/emulsion polymer system continuously for changes in consistency, gelling, or deterioration in properties. A similar, but less rigorous example of such types of assessments is ASTM D1849. The loss of stability occurs when the resin/emulsion polymer system undergoes any of the following: gelling, flocculation, gassing, loss of liquid flowability, phase separation, other phase changes, or degradation in performance in less than 2 years under sealed ambient conditions or in less than 30 days in sealed controlled accelerated testing (as indicated above).

In some embodiments of the method, the organic premix comprising the aqueous fluid and the aqueous resins is provided, and the high HLB surfactant is added to the organic premix to yield a mixture of organic premix and high HLB surfactant with emulsified aqueous resins. An industrial fluid or coating characterized by an “extreme” chemical environment (e.g., and acidic passivate) may thereafter be added to the mixture of organic premix and high HLB surfactant to yield the composition of stabilized aqueous resins/emulsion polymers within an “extreme” chemical environment. In some embodiments, the industrial fluid or coating characterized by an “extreme” chemical environment (e.g., acidic passivate) may be added to the mixture of organic premix and high HLB surfactant in a slow manner, or in a step-wise fashion, wherein a portion of the acidic passivate is added slowly, then progressively faster, to prevent flocculation.

In another embodiment, there is a stabilized resin emulsion system. The stabilized resin emulsion system comprises an emulsified aqueous resin; an aqueous fluid characterized by an extreme chemical environment having a high ionic strength (e.g., an acidic passivate); and a high hydrophobic-lipophilic balance (HLB) surfactant.

### DETAILED DESCRIPTION OF THE INVENTION

It has been surprisingly found that aqueous resins/emulsion polymers can be stabilized in aqueous industrial or coating fluids having “extreme” chemical conditions without chemically altering the resins/emulsion polymers themselves. Previously, organic resins such as epoxies or acrylic polymer emulsions were difficult to stabilize within extreme chemical environments, such as highly acidic mediums (pH<3), highly basic mediums (pH>11), and environments characterized by high concentrations of electrolytes (e.g., high concentrations of phosphates, nitrates). However, it has been surprisingly found that resins/emulsion polymers can easily be formulated into commercial specialty coatings and industrial fluids as additives in accordance with the methods herein, without requiring costly and complicated polymeric stabilization techniques or reactive surfactants which fundamentally alter the chemistry and properties of the resins/emulsion polymers themselves. Notably, embodiments of the processes according to the invention herein provide a simple, universal means by which a chemical formulator can stabilize a broader variety of resins in a greater variety of aqueous industrial fluids/coatings characterized by “extreme” chemical environments.

A process according to embodiments of the invention herein will ideally involve commercially and ubiquitously available non-water soluble (e.g., emulsified/water-dispersed) resins, surfactants, industrial fluids/coatings, and other materials easily accessible to chemical formulators. Further, the processes will result in stabilized resins/polymer emulsions and ideally avoid complicated polymerization processes requiring multiple components (including polymeric stabilizers) and chemical changes to the resins/emulsion polymers that might undermine their useful industrial properties. Finally, the processes will provide a universal process for producing stabilized aqueous resin emulsions in aqueous environments having “extreme” chemical conditions-those characterized by high ionic strength and/or extremes of pH.

In some embodiments methods of the present invention are useful to produce industrial fluids or coatings having stabilized and emulsified resin additives that are useful for various substrates. Such industrial fluids/coatings demonstrate high water repellency, pot life extension, resistance to syneresis (gelling and separation of liquid), great film strength, greatly improved metal corrosion performance vs comparable compositions, high adhesion, and improved self-healing ability (slower spread of corrosion). Substrates for which these industrial fluids/coatings may be useful include, but are not limited to, steel alloys, galvanized steel, galvalume, galvanneal, aluminized, or other metals. Substrates may also include non-metals, including wood, plastic, or textiles.

Exemplary methods of stabilizing aqueous resins/emulsion polymers within an aqueous fluid characterized by an extreme chemical environment having a high ionic strength and/or extremes of pH include combining an “organic premix” comprising the aqueous fluid and the aqueous resins/emulsion polymers with a high hydrophobic-lipophilic balance (HLB) surfactant and an aqueous fluid characterized by an extreme chemical environment having a high ionic strength and/or extremes of pH (e.g., an acidic passivate) to yield a composition wherein emulsified aqueous resins are stabilized despite the “extreme” environment. The high HLB surfactants may be non-reactive surfactants; that is, the non-reactive surfactants associate with the resins/emulsion polymers through non-chemically altering interactions and do not form, for example, covalent bonds with the resins/emulsion polymers. Such non-reactive surfactants do not alter the chemical and physical properties of the resins/emulsion polymers.

An “organic premix” includes an aqueous fluid. The aqueous fluid of the organic premix may be, or comprise, an industrial fluid or coating composition. The aqueous fluid of the organic premix may also comprise industrial passivation fluid that is already stable, and which can be combined with an “extreme environment” acidic passivation fluid (in which the resin(s)/emulsion polymer(s) in the organic premix would otherwise be unstable, without the systems and methods of the present invention) in accordance with embodiment of the methods herein.

Moreover, the “organic premix” includes organic, aqueous resin(s)/emulsion polymer(s), such that in some embodiments the organic aqueous resin(s)/emulsion polymer(s) are separate from the aqueous fluid of the organic premix and are not yet emulsified (such emulsification may not occur until addition of a suitable surfactant, such as a high HLB surfactant). Chemical species suitable as organic, aqueous resins include, but are not limited to, acrylic, epoxy, polyurethane, polyvinylidene chloride, or hybridized (i.e., part acrylic and epoxy character). Examples of suitable resins is the acrylic resin Alberdingk AC2360 and the epoxy acrylic hybrid Alberdingk M2959.

In some embodiments, the addition of high HLB surfactant to the organic premix causes emulsification of the aqueous resins. The emulsified aqueous resins may be or comprise emulsion polymers.

The “organic premix” may also optionally include a number of additives. These additives may include surfactants, waxes, defoamers, film-forming aids, wetting aids, fillers, plasticizers, pigments, rheology additives, or any other additives useful for the industrial application of choice

Suitable high HLB surfactants include the class of nonionic ethoxylated surfactants, such as Tomadol 91-8 and Triton X-405. A “high HLB surfactant” is any that has an HLB value of 8 or higher. A suitable range of HLB value for the purpose of metal corrosion protection is generally found to be around 8-18. In addition, since various aqueous resin systems have varying emulsification properties, a “high HLB surfactant” may also mean any surfactant with an HLB value that is high enough to stabilize the system within an aqueous formulation. The methods, systems, and formulations according to embodiments of the invention herein use between about 0.30 wt % to about 4.0 wt % high HLB surfactants.

Further exemplary methods of stabilizing aqueous resins/emulsion polymers within an aqueous fluid characterized by an extreme chemical environment having a high ionic strength and/or extremes of pH include combining an aqueous resin/emulsion polymer with a high hydrophobic-lipophilic balance (HLB) surfactant and an industrial fluid or coating characterized by an “extreme chemical environment” (e.g., an acidic passivate) to yield a composition wherein emulsified aqueous resins are stabilized in the “extreme” environment.

The industrial fluid or coating characterized by an “extreme” chemical environment may be an acidic passivate. Suitable acidic passivates includes one or more acidic passivates in which a passivating species is used to provide a surface (e.g., metal) with increased corrosion protection. This includes, but is not limited to, transition metal species common and novel in industry such as species of chromium, vanadium, manganese, zinc, titanium, and combinations thereof. The suitable acidic passivates may also comprise of species of nonmetals such as silicon, phosphorous, nitrogen, and combinations thereof.

Suitable aqueous industrial fluids, coatings, and/or industrial passivation fluids used in the claimed methods and formulations according to aspects of the invention herein may have “extreme” chemical environments characterized by high ionic strength—in turn characterized by any ionic strength exceeding the typical stability requirements and/or critical coagulation concentration (CCC) of the resin(s)/emulsion polymer(s) used in the system. The high ionic strength may be derived from substantial concentrations of electrolytes, especially strong electrolyte systems that interact with the electrical double layer of the emulsion system within the emulsified resins/polymers or organic premix. Classes of electrolytes imparting high ionic strength include, but are not limited to, the salts of nitric acid, phosphoric acid, HEDP, Chromium (III), other passivating metals, as well as substances completely dissociated to form ionic interactions in aqueous solution which are useful for various industrial applications. The extreme chemical environment may be alternatively or further characterized by any pH that destabilizes the organic premix system, which may generally fall within a pH of lower than about 3 or greater than about 11. For example, many industrial passivation fluids are characterized by a low pH, e.g., a pH of less than about 3.

The “organic premix” portion of a composition according to aspects of the invention herein may also be formulated as a “receiving” fluid, which receives addition of another fluid comprising an “extreme environment” in some instances; e.g., in cases where the resin/emulsion polymer system is not stable when the “organic premix” portion is added to the fluid characterized by the “extreme environment”. For example, a suitable water incompatible resin or blend of resins is added to a portion of DI water at a loading of 0.5-50% w/w solids to form an “organic premix”. Other additives, such as defoamer and waxes are optionally added to the “organic premix” at the loading necessary for the industrial application of choice. The diluted resin “organic premix” is mixed with a stabilizing high HLB surfactant of choice (e.g., with a loading of 0.1-15% ww). An acidic passivate fluid comprising an “extreme environment” in the context of the resin(s)/emulsion polymer(s) present in the “organic premix” may then be added to high HLB surfactant-stabilized “organic premix” to yield a stable resin/emulsion polymer system in accordance with aspects of the present invention.

In some embodiments of the method, the aqueous resins are stabilized within the “extreme” environment for 30 days under accelerated conditions characterized by high and low temperatures. In particular embodiments, a stabilized aqueous resin prepared in accordance with aspects of the invention remains stable for at least 30 days at 60° C. sealed within an oven, and also remains stable for at least 30 days at 5° C. sealed within a refrigerated environment. In other embodiments, a stabilized aqueous resin prepared in accordance with the invention remains stable at ambient conditions/room temperature within a sealed container for at least 2 years. Stability of the resultant aqueous resin/polymer emulsion compositions may be determined by observing a phase change in the compositions. A stable composition in accordance with the invention may have a liquid consistency suitable, for example, for application to substrate surfaces as a roll coating. Instability of such compositions may be observed when such a “liquid” composition begins to gel, thicken, or solidify. Other methods of determining a phase change from stable to unstable include changes in the composition from translucent to opaque, or the appearance of precipitation or settling of particles within the compositions.

In some embodiments, the resultant stabilized aqueous resin/polymer emulsion compositions may comprise from about 0.5 wt % to about 50 wt % aqueous resins/polymer emulsions, 1 wt % to about 40 wt % aqueous resins/polymer emulsions, or about 2 wt % to about 30 wt % aqueous resins/polymer emulsions, or about 3 wt % to about 20 wt % aqueous resins/polymer emulsions, or about 4 wt % to about 10 wt % aqueous resins/polymer emulsions, or about 5 wt % to about 9 wt % aqueous resins/polymer emulsions, or about 6 wt % to about 8 wt % aqueous resins/polymer emulsions. In some embodiments the resultant stabilized aqueous resin/polymer emulsion compositions may comprise about 0.5 wt % aqueous resins/polymer emulsions, 1 wt % aqueous resins/polymer emulsions, about 2 wt % aqueous resins/polymer emulsions, about 3 wt % aqueous resins/polymer emulsions, about 4 wt % aqueous resins/polymer emulsions, about 5 wt % aqueous resins/polymer emulsions, about 6 wt % aqueous resins/polymer emulsions, about 7 wt % aqueous resins/polymer emulsions, about 8 wt % aqueous resins/polymer emulsions, about 9 wt % aqueous resins/polymer emulsions, about 10 wt % aqueous resins/polymer emulsions, about 20 wt % aqueous resins/polymer emulsions, about 30 wt % aqueous resins/polymer emulsions, about 40 wt % aqueous resins/polymer emulsions, or about 50 wt % aqueous resins/polymer emulsions.

In some embodiments, the resultant stabilized aqueous resin/polymer emulsion compositions may comprise from about 0 wt % to about 85 wt % water, or from about 5 wt % to about 80 wt % water, from about 10 wt % to about 75 wt % water, from about 15 wt % to about 70 wt % water, from about 20 wt % to about 65 wt % water, from about 25 wt % to about 60 wt % water, from about 30 wt % to about 55 wt % water, from about 35 wt % to about 50 wt % water, or from about 40 wt % to about 45 wt % water. In some embodiments, the water may be DI water.

In some embodiments, the resultant stabilized aqueous resin/polymer emulsion compositions may comprise from about 0.1 wt % to about 15 wt % high HLB surfactants, or about 1 wt % to about 14 wt % high HLB surfactants, or about 2 wt % to about 13 wt % high HLB surfactants, or about 3 wt % to about 12 wt % high HLB surfactants, or about 4 wt % to about 11 wt % high HLB surfactants, or about 5 wt % to about 10 wt % high HLB surfactants, or about 6 wt % to about 9 wt % high HLB surfactants, or about 7 wt % to about 8 wt % high HLB surfactants. In some embodiments, the resultant stabilized aqueous resin/polymer emulsion compositions may comprise about 0.4 wt % high HLB surfactants, about 1 wt % high HLB surfactants, about 2 wt % high HLB surfactants, about 3 wt % high HLB surfactants, about 4 wt % high HLB surfactants, about 5 wt % high HLB surfactants, about 6 wt % high HLB surfactants, about 7 wt % high HLB surfactants, about 8 wt % high HLB surfactants, about 9 wt % high HLB surfactants, about 10 wt % high HLB surfactants, about 11 wt % high HLB surfactants, about 12 wt % high HLB surfactants, about 13 wt % high HLB surfactants, about 14 wt % high HLB surfactants, or about 15 wt % high HLB surfactants. In some embodiments, the amount of high HLB surfactant may be increased as the ionic strength of the aqueous fluid increases to maintain stability of the aqueous resins/polymer emulsions.

In some embodiments, the high HLB surfactant has an HLB value of between about 8 and about 18, between about 9 and 17, between about 10 and 16, between about 11 and 15, or between about 12 and 14. In some embodiments of the invention herein, the high HLB surfactant has an HLB value of at least about 8, of at least about 9, of at least about 10, of at least about 11, of at least about 12, of at least about 13, of at least about 14, of at least about 15, of at least about 16, or of at least about 17. In some embodiments, the high HLB surfactant has an HLB value of about 8, of about 9, of about 10, of about 11, of about 12, of about 13, of about 14, of about 15, of about 16, of about 17, or of about 18.

In some embodiments, the resultant stabilized aqueous resin/polymer emulsion compositions may comprise from about 1 wt % to about 20 wt % additives (e.g., wax, defoamer, rheology modifiers, pigments, fillers), or from about 5 wt % to about 16 wt % additives, or from about 9 wt % to about 12 wt % additives.

In some embodiments, the resultant stabilized aqueous resin/polymer emulsion compositions may comprise from about 1 wt % to about 85 wt % industrial fluid or coating having an “extreme” chemical environment, or from about 5 wt % to about 80 wt % industrial fluid or coating having an “extreme” chemical environment, from about 10 wt % to about 75 wt % industrial fluid or coating having an “extreme” chemical environment, from about 15 wt % to about 70 wt % industrial fluid or coating having an “extreme” chemical environment, from about 20 wt % to about 65 wt % industrial fluid or coating having an “extreme” chemical environment, from about 25 wt % to about 60 wt % industrial fluid or coating having an “extreme” chemical environment, from about 30 wt % to about 55 wt % industrial fluid or coating having an “extreme” chemical environment, from about 35 wt % to about 50 wt % industrial fluid or coating having an “extreme” chemical environment, or from about 40 wt % to about 45 wt % industrial fluid or coating having an “extreme” chemical environment.

In some embodiments, the resultant stabilized aqueous resin/polymer emulsion compositions may comprise acidic passivation fluid. The acidic passivation fluid may have a pH of less than about 3. The stabilized aqueous resin/polymer emulsion compositions in accordance with the invention may comprise from about 1 wt % to about 85 wt % acidic passivation fluid, or from about 5 wt % to about 80 wt % acidic passivation fluid, from about 10 wt % to about 75 wt % acidic passivation fluid, from about 15 wt % to about 70 wt % acidic passivation fluid, from about 20 wt % to about 65 wt % acidic passivation fluid, from about 25 wt % to about 60 wt % acidic passivation fluid, from about 30 wt % to about 55 wt % acidic passivation fluid, from about 35 wt % to about 50 wt % acidic passivation fluid, or from about 40 wt % to about 45 wt % acidic passivation fluid.

In some embodiments, the resultant stabilized aqueous resin emulsion compositions may comprise from about 15 wt % to about 95 wt % organic premix, or from about 20 wt % to about 90 wt % organic premix, or from about 25 wt % to about 85 wt % organic premix, or about 30 wt % to about 80 wt % organic premix, or about 35 wt % to about 75 wt % organic premix, or about 40 wt % to about 70 wt % organic premix.

In some embodiments of the method, the organic premix comprising the aqueous fluid and the aqueous resins/emulsion polymers is provided. The organic premix may already contain high HLB surfactant (e.g., to stabilize the resin(s)/emulsion polymer(s) in the aqueous environment). In some embodiments, the high HLB surfactant is present in the organic premix in an amount that is not sufficient to stabilize the resins/emulsion polymers within an “extreme” chemical environment of typical industrial fluids and/or coatings). In some embodiments, the organic premix may already be provided with high HLB surfactant to stabilize the resin(s)/emulsion polymer(s) in the aqueous environment, and additional high HLB surfactant may be added to stabilize the resins/emulsion polymers within an “extreme” chemical environment of typical industrial fluids and/or coatings.

In other embodiments, the organic premix may be provided without high HLB surfactant, and high HLB surfactant may be added to the organic premix to yield organic premix containing high HLB surfactant. The industrial fluid or coating having an “extreme” chemical environment (e.g., acidic passivate) may thereafter be added to the organic premix containing the high HLB surfactant to yield the inventive composition. The industrial fluid or coating having an “extreme” chemical environment (e.g., acidic passivate) may be added to the organic premix containing high HLB surfactant in a step-wise fashion to yield a stabilized resin/emulsion polymer system. The industrial fluid or coating having an “extreme” chemical environment (e.g., acidic passivate) may also be added slowly at first until the mixture is stable enough to add the industrial fluid or coating having an “extreme” chemical environment (e.g., acidic passivate) having an extreme environment to the mixture in a progressively faster manner.

In some embodiments, a stabilized resin emulsion within a fluid having an “extreme” chemical environment is provided. The stabilized resin emulsion comprises an emulsified aqueous resin/emulsion polymer; an industrial fluid or coating characterized by an extreme chemical environment having a high ionic strength and/or high or low pH; a high hydrophobic-lipophilic balance (HLB) surfactant; and an acidic passivate.

In some embodiments, a stabilized resin emulsion within a fluid having an “extreme” chemical environment is provided. The stabilized resin emulsion comprises aqueous resin(s)/emulsion polymers; an industrial fluid or coating characterized by an extreme chemical environment having a high ionic strength and/or high or low pH; and a high hydrophobic-lipophilic balance (HLB) surfactant.

In some embodiments, a stabilized resin emulsion within a fluid having an “extreme” chemical environment is provided. The stabilized resin emulsion comprises an “organic premix” containing aqueous resin(s)/emulsion polymers and an aqueous fluid; a high hydrophobic-lipophilic balance (HLB) surfactant; and an industrial fluid or coating characterized by an extreme chemical environment having a high ionic strength and/or high or low pH. The “organic premix” may contain one or more additives within the aqueous fluid, and the “organic premix” may or may not already contain high HLB surfactant.

TABLE 1
Resin-Enhanced Passivation Formulations (organic premix including
high HLB surfactant plus acidic passivation fluid)

| | | Percentage | Percentage |
|---|---|---|---|
| | | by weight | by weight |
| | | minimum of | maximum of |
| COMPONENTS | | formulation | formulation |
| Organic | Resins/emulsion | 0.5 | 50 |
| Premix | polymers | | |
| | DI water | 0 | 85 |
| | High HLB | 0.1 | 15 |
| | Surfactant/stabilizer | | |
| | Additives (wax, | 1 | 20 |
| | defoamer, rheology | | |
| | modifiers, pigment, | | |
| | fillers, etc.) | | |
| Acidic | | 1 | 85 |
| passivation | | | |
| fluid | | | |

Stable formulations according to embodiments of the invention set forth herein may include organic premix comprising resins/emulsion polymers, water (e.g., DI water), additives (e.g., wax, defoamer, rheology modifiers, pigment, fillers), and high HILB surfactants. The formulations further comprise extreme environment acidic passivation fluid (e.g., industrial fluid having a pH of less than about 3).

TABLE 2
Stabilization of Various Cr-Free Acidic Passivation/Organic Premix Systems Subjected to Accelerated Stability Testing at 60° C.

| | | | Organic Premix | | | | |
|---|---|---|---|---|---|---|---|
| | | | % w/w | | | | |
| | | | Organic Premix | | | | |
| | Acidic passivation fluid | | (resin/emulsion | | | | |
| | Passivation Fluid | | polymer, water, | | High HLB Surfactant | | |
| | Composition/De- | | and/or additives | | | % w/w | Days |
| | Stabilizing Species | | without high | Resin System/wt % | | high HLB | stable |
| Formulation | and wt % within | % Passivate | HLB surfactant/ | of resin in final | Surfactant/ | Surfactant | at |
| Name | Passivation Fluid | (% w/w) | stabilizer) | formulation | Stabilizer System | Added | 60° C. |
| 4444-85 | 0.18% | 47.1 | 52.9 | AC 2360/19.12 wt % | None | 0 | 0 |
| CTRL | Al(H2PO4)3/12.10% Al | | | | | | |
| | (NO3)3/0.1% H2ZrF6/ | | | | | | |
| | 5.10% HEDP | | | | | | |
| 4444-85A | 0.18% | 47.1 | 51.47 | AC 2360/19.12 wt % | Triton X-405 | 1.43 | 10 |
| | Al(H2PO4)3/12.10% Al | | | | (70%) | | |
| | (NO3)3/0.1% H2ZrF6/ | | | | | | |
| | 5.10% HEDP | | | | | | |
| 4444-85B | 0.18% | 47.1 | 50.47 | AC 2360/19.12 wt % | Triton X-405 | 2.43 | >30 |
| | Al(H2PO4)3/12.10% Al | | | | (70%) | | |
| | (NO3)3/0.1% H2ZrF6/ | | | | | | |
| | 5.10% HEDP | | | | | | |
| 4444-85C | 0.18% | 47.1 | 49.47 | AC 2360/19.12 wt % | Triton X-405 | 3.43 | >30 |
| | Al(H2PO4)3/12.10% Al | | | | (70%) | | |
| | (NO3)3/0.1% H2ZrF6/ | | | | | | |
| | 5.10% HEDP | | | | | | |
| 4444-86A | 0.18% | 47.1 | 51.47 | AC 2360/19.12 wt % | Triton X-405 | 1.43 | 13 |
| | Al(H2PO4)3/12.10% Al | | | | (70%) | | |
| | (NO3)3/1.0% H2ZrF6/ | | | | | | |
| | 5.10% HEDP | | | | | | |
| 4444-86C | 0.18% | 47.61 | 49.47 | AC 2360/19.12 wt % | Triton X-405 | 3.43 | >30 |
| | Al(H2PO4)3/12.10% Al | | | | (70%) | | |
| | (NO3)3/1.0% H2ZrF6/ | | | | | | |
| | 5.10% HEDP | | | | | | |

TABLE 3
Stabilization of Various Cr (III) Acidic Passivation/Organic Premix Systems Subjected to Accelerated Stability Testing at 60° C.

| | | | Organic Premix | | | | |
|---|---|---|---|---|---|---|---|
| | | | | % w/w | | | |
| | | | | Organic Premix | | | |
| | Acidic passivation fluid | | | (resin/emulsion | | | |
| | Passivation Fluid | | | polymer water, | High HLB surfactant | | |
| | Composition/De- | | | and/or additives | | % w/w | Days |
| | Stabilizing Species | | Resin System/wt % | without high | | high HLB | stable |
| Formulation | and wt % within | % Passivate | of resin in final | HLB surfactant/ | Surfactant/ | Surfactant | at |
| Name | Passivation Fluid | (% w/w) | Formulation | stabilizer) | Stabilizer System | Added | 60° C. |
| 4444-59A | Cr *: 3-8 wt % | 16.3 | Haloflex 202/60 | 81.7 | Ca | 2 | 5 |
| | HNO3: 10-15 wt % | | wt % | | Lignosulfonate | | |
| | H3PO4: 5-10 wt % | | | | | | |
| 4444-59B | Cr *: 3-8 wt % | 16.3 | Haloflex 202/30 | 81.7 | Ca | 2 | 0 |
| | HNO3: 10-15 wt % | | wt % | | Lignosulfonate | | |
| | H3PO4: 5-10 wt % | | AC 2486/30 wt % | | | | |
| 4444-59C | Cr *: 3-8 wt % | 16.3 | Haloflex 202/60 | 81.7 | Ca | 2 | 7 |
| | HNO3: 10-15 wt % | | wt % | | Lignosulfonate/ | | |
| | H3PO4: 5-10 wt % | | | | Tripolyphosphate | | |
| 4444-59D | Cr *: 3-8 wt % | 16.3 | Haloflex 202/60 | 81.7 | Acumer 1510/Ca | 2 | 5 |
| | HNO3: 10-15 wt % | | wt % | | Lignosulfonate | | |
| | H3PO4: 5-10 wt % | | | | | | |
| 4444-60A | Cr *: 3-8 wt % | 16.3 | Haloflex 202/60 | 81.9 | Tomadol 91-8 | 1.8 | 23 |
| | HNO3: 10-15 wt % | | wt % | | | | |
| | H3PO4: 5-10 wt % | | | | | | |
| 4444-60C | Cr *: 3-8 wt % | 32.6 | Haloflex 202/60 | 64.4 | Tomadol 91-8 | 3 | >30 |
| | HNO3: 10-15 wt % | | wt % | | | | |
| | H3PO4: 5-10 wt % | | | | | | |
| | (50% in DI) | | | | | | |
| 4444-60D | Cr *: 3-8 wt % | 32.6 | Haloflex 202/50 | 64.4 | Tomadol 91-8 | 3 | >30 |
| | HNO3: 10-15 wt % | | wt % | | | | |
| | H3PO4: 5-10 wt % | | | | | | |
| | (50% in DI) | | | | | | |
| 4444-60E | Cr *: 3-8 wt % | 32.6 | AC 2486/50 wt % | 64.4 | Tomadol 91-8 | 3 | >30 |
| | HNO3: 10-15 wt % | | | | | | |
| | H3PO4: 5-10 wt % | | | | | | |
| | (50% in DI) | | | | | | |
| 4444-60F | Cr *: 3-8 wt % | 32.6 | Luhydran/50 wt % | 64.4 | Tomadol 91-8 | 3 | >30 |
| | HNO3: 10-15 wt % | | | | | | |
| | H3PO4: 5-10 wt % | | | | | | |
| | (50% in DI) | | | | | | |
| 4444-61A | Cr *: 3-8 wt % | 22.82 | XK-30/35 wt % | 75.78 | Tomadol 91-8 | 1.4 | 12 |
| | HNO3: 10-15 wt % | | | | | | |
| | H3PO4: 5-10 wt % | | | | | | |
| | (50% in DI) | | | | | | |
| 4444-61C | Cr *: 3-8 wt % | 22.82 | XK-30/25 wt % | 75.78 | Tomadol 91-8 | 1.4 | 12 |
| | HNO3: 10-15 wt % | | | | | | |
| | H3PO4: 5-10 wt % | | Haloflex 202/10 | | | | |
| | (50% in DI) | | wt % | | | | |
| 4444-62A | Cr *: 3-8 wt % | 22.82 | XK-30/35 wt % | 77.18 | None | 0 | 1 |
| | HNO3: 10-15 wt % | | | | | | |
| | H3PO4: 5-10 wt % | | | | | | |
| | (50% in DI) | | | | | | |
| 4444-63A | Cr *: 3-8 wt % | 22.82 | AC 2360/63 wt % | 75.38 | Tomadol 91-8 | 1.8 | >30 |
| | HNO3: 10-15 wt % | | | | | | |
| | H3PO4: 5-10 wt % | | | | | | |
| | (50% in DI) | | | | | | |
| 4444-64A | Cr *: 5-8 wt % | 85 | AC 2360/35 wt % | 15 | None | 0 | 0 |
| 4444-64B | Cr *: 5-8 wt % | 82 | AC 2360/35 wt % | 15 | Tomadol 91-8 (to | 3 | >30 |
| | | | | | organic premix) | | |
| 4444-64C | Cr *: 5-8 wt % | 82 | AC 2360/35 wt % | 15 | Tomadol 91-8 (to | 3 | 0 |
| | | | | | passivate) | | |
| 444-67B | Cr *: 5-8 wt % | 79.9 | AC 2360/35 wt % | 19.1 | Tomadol 91-8 | 1 | >30 |
| 4444-67C | Cr *: 5-8 wt % | 80.4 | AC 2360/35 wt % | 19.1 | Tomadol 91-8 | 0.5 | >30 |
| 4444-67D | Cr *: 5-8 wt % | 80.65 | AC 2360/35 wt % | 19.1 | Tomadol 91-8 | 0.25 | 18 |
| 4444-70C | Cr *: 3-8 wt % | 13.692 | AC 2360/42 wt % | 84.508 | Tomadol 91-8 | 1.8 | 1 |
| | HNO3: 2-5 wt % | | | | | | |
| | H3PO4: 5-10 wt % | | | | | | |
| 4444-71C | Cr *: 3-8 wt % | 13.692 | AC 2360/42 wt % | 84.508 | Triton X- | 1.8 | <30 |
| | HNO3: 2-5 wt % | | | | 405(70%) | | |
| | H3PO4: 5-10 wt % | | | | | | |
| 4444-79A | Cr *: 3-8 wt % | 11.41 | AC 2360/35 wt % | 87.09 | Tomado 91-8 | 1.5 | 10 |
| | HNO3: 2-5 wt % | | | | | | |
| | H3PO4: 5-10 wt % | | | | | | |
| 4444-79B | Cr *: 3-8 wt % | 11.41 | AC 2360/35 wt % | 87.09 | Tomadol 91-8 | 1.5 | 0 |
| | HNO3: 2-5 wt % | | | | | | |
| | H3PO4: 2-5 wt % | | | | | | |
| 4444-79C | Cr *: 3-8 wt % | 22.82 | AC 2360/35 wt % | 75.68 | Tomadol 91-8 | 1.5 | 0 |
| | HNO3: 5-10 wt % | | | | | | |
| | H3PO4: 5-10 wt % | | | | | | |
| | HEDP: 5-10 wt % | | | | | | |
| | (50% in DI) | | | | | | |
| 4444-80A | Cr *: 3-8 wt % | 11.41 | AC 2360/35 wt % | 87.09 | Tomadol 91-8 | 1.5 | 0 |
| | HNO3: 5-10 wt % | | | | | | |
| | H3PO4: 5-10 wt % | | | | | | |
| | HEDP: 5-10 wt % | | | | | | |
| 4444-81C | Cr *: 3-8 wt % | 11.41 | AC 2360/35 wt % | 86.59 | Tomadol 91-8 | 2 | 0 |
| | HNO3: 2-5 wt % | | | | | | |
| | H3PO4: 5-10 wt % | | | | | | |
| 4444-81D | Cr *: 3-8 wt % | 11.41 | AC 2360/35 wt % | 85.69 | Triton X-405 | 2.9 | >30 |
| | HNO3: 2-5 wt % | | | | (70%) | | |
| | H3PO4: 5-10 wt % | | | | | | |
| 4444-84A | Cr *: 3-8 wt % | 11.41 | AC 2360/30-40 | 86.72 | Triton X-405 | 1.87 | >30 |
| | HNO3: 5-10 wt % | | wt % | | (70%) | | |
| | H3PO4: 2-5 wt % | | | | | | |
| | HEDP: 8-12 wt % | | | | | | |
| 4444-84B | Cr *: 3-8 wt % | 11.41 | AC 2360/30-40 | 86.72 | Triton X-405 | 1.87 | >30 |
| | HNO3: 5-10 wt % | | wt % | | (70%) | | |
| | H3PO4: 5-10 wt % | | | | | | |
| | HEDP: 5-10 wt % | | | | | | |
| 4444-84AM1 | Cr *: 3-8 wt % | 9.41 | AC 2360/50-60 | 88.38 | Triton X-405 | 2.21 | >30 |
| | HNO3: 5-10 wt % | | wt % | | | | |
| | H3PO4: 2-5 wt % | | | | | | |
| | HEDP: 8-12 wt % | | | | | | |
| 4444-84AM3 | Cr *: 3-8 wt % | 13.8 | AC 2360/50-60 | 82.99 | Triton X-405 | 3.21 | >30 |
| | HNO3: 5-10 wt % | | wt % | | | | |
| | H3PO4: 2-5 wt % | | | | | | |
| | HEDP: 8-12 wt % | | | | | | |
| 5036-3BM1 | Cr *: 3-8 wt % | 77.93 | AC 2360/10-20 | 15.56 | Triton X-405 | 0.7 | >30 |
| | HNO3: 5-10 wt % | | wt % | | | | |
| | H3PO4: 2-5 wt % | | | | | | |
| | HEDP: 8-12 wt % | | | | | | |
| 5036-3BM2 * | Cr *: 3-8 wt % | 77.93 | AC 2360/10-20 | 15.56 | Marlipal O | 0.7 | >30 |
| | HNO3: 5-10 wt % | | wt % | | 13/100 | | |
| | H3PO4: 2-5 wt % | | | | | | |
| | HEDP: 8-12 wt % | | | | | | |
| F4-R | Cr *: 3-10 wt % | 93 | AC 2360/5-10 | 6 | Marlipal O | 1 | NA |
| | HNO3: 2-5 wt % | | wt % | | 13/100 | | |
| | H3PO4: 5-10 wt % | | | | | | |
| F4-R | Cr *: 3-10 wt % | 93 | AC 2360/5-10 | 6 | Marlipal O | 1 | NA |
| | HNO3: 2-5 wt % | | wt % | | 13/100 | | |
| | H3PO4: 5-10 wt % | | | | | | |

* It is to be understood that percent total atomic Cr species embodies Cr in its different salts, such as, but not limited to, Chromium trinitrate and Chromium orthophosphate.

TABLE 4
Stabilization of Various Cr (III) Acidic Passivation/Organic Premix Systems Subjected to Ambient Testing Conditions (25° C.)

| | | | Organic Premix | | | | |
|---|---|---|---|---|---|---|---|
| | | | | % w/w | | | |
| | | | | Organic Premix | | | |
| | | | | (resin/emulsion | | | |
| | | | | polymer water, | High HLB surfactant | | Days |
| | | | | and/or additives | | % w/w | stable |
| | Acidic passivation fluid | | Resin System/wt % | without high | | high HLB | at |
| Formulation | Passivation Fluid | % Passivate | of resin in final | HLB surfactant/ | Surfactant/ | Surfactant | Ambient |
| Name | Composition | (% w/w) | Formulation | stabilizer) | Stabilizer System | Added | Conditions |
| 63A | Cr *: 3-8 wt % | 22.82 (11.41) | AC 2360/63 wt % | 75.38 | Tomadol 91-8 | 1.8 | >365 days |
| | HNO3: 10-15 wt % | | | | | | |
| | H3PO4: 5-10 wt % | | | | | | |
| | (50% in DI) | | | | | | |
| 70A | Cr *: 3-8 wt % | 11.41 | AC 2360/35 wt % | 75.38 | Tomadol 91-8 | 1.5 | 160 days |
| | HNO3: 2-5 wt % | | | | | | |
| | H3PO4: 5-10 wt % | | | | | | |
| 70C | Cr *: 3-8 wt % | 13.692 | AC 2360/42 wt % | 84.508 | Tomadol 91-8 | 1.8 | 93 days |
| | HNO3: 2-5 wt % | | | | | | |
| | H3PO4: 5-10 wt % | | | | | | |
| 79A | Cr *: 3-8 wt % | 11.41 | AC 2360/35 wt % | 87.09 | Tomadol 91-8 | 1.5 | >10 |
| | HNO3: 5-10 wt % | | | | | | |
| | H3PO4: 5-10 wt % | | | | | | |
| | HEDP: 5-10 wt % | | | | | | |
| 79B | Cr *: 3-8 wt % | 11.41 | AC 2360/35 wt % | 87.09 | Tomadol 91-8 | 1.5 | 7 |
| | HNO3: 2-5 wt % | | | | | | |
| | H3PO4: 2-5 wt % | | | | | | |
| 79C | Cr *: 3-8 wt % | 22.82 | AC 2360/35 wt % | 75.68 | Tomadol 91-8 | 1.5 | 10 |
| | HNO3: 5-10 wt % | | | | | | |
| | H3PO4: 5-10 wt % | | | | | | |
| | HEDP: 5-10 wt % | | | | | | |
| | (50% in DI) | | | | | | |

TABLE 5
Time Until Failure (in Hours) Of Standard Coating Composition in Comparison to Compositions
According to the Invention for Hot Dip Galvanized Steel and Galvalume Steel

| | | | Time of Neutral Salt Spray Failure (hrs at ≥5% corrosion) | | | |
|---|---|---|---|---|---|---|
| | | Coating | HD | HD | | |
| | | Weight | Galvanized | Galvanized | Galvalume | Galvalume |
| | | (mg | (Mill 1 | (Mill 2 | (Mill 1 | (Mill 2 |
| Formulation | Chemistry | Cr/ft²) | high grade) | low grade) | high grade) | low grade) |
| Control | Cr(III) | 2.5 | 192 | 120 | Not | Not |
| Formulation 1 | 5-8 wt % | | | | Tested | Tested |
| Control | Cr(III) 2-5 | 2.5 | 312 | Not | 72 | 48 |
| Formulation 2 | wt % + Resin | | | Tested | | |
| Control | Cr(VI) 10-15 | 2.0 | 312 | Not | 912 | 480 |
| Formulation 3 | wt % + Resin | | | Tested | | |
| 4444-84AM3 | Cr(III) | 2.5 | 336 | Not | 744 | 312 |
| | 3-8 wt % + | | | Tested | | |
| | Stabilized | | | | | |
| | resin 50-60 | | | | | |
| | wt % | | | | | |
| 4444-84AM4 | Cr(III) | 2.5 | 360 | 144 | Not | 192 |
| | 3-8 wt % + | | | | Tested | |
| | Stabilized | | | | | |
| | resin 50-60 | | | | | |
| | wt % | | | | | |
| 5036-03B | Cr(III) | 2.5 | Not | 264 | 1200* | Not |
| | 3-8 wt % + | | Tested | | | Tested |
| | Stabilized | | | | | |
| | resin 10-20 | | | | | |
| | wt % | | | | | |

Table 5 provides a compilation of different performances across two different steel manufacturers for Hot dip galvanized (HDG) and Galvalume (total of 4 substrates). The data covers performance across low grade (fast failure) and high grade (slow failure) substrate. Control Formulations 1, 2, and 3 are formulations lacking the stabilization systems and are produced according to methods not utilizing the stabilization methods of the present invention herein.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

I/We claim:

1. A method for stabilizing emulsified aqueous resins or polymers within a fluid characterized by an extreme chemical environment having a stability-incompatible pH and/or ionic strength for the emulsified aqueous resins or polymers, the method comprising:
combining an organic premix comprising an aqueous fluid and the emulsified aqueous resins or polymers with a high hydrophobic-lipophilic balance (HLB) surfactant and the fluid characterized by the extreme chemical environment to yield a composition wherein the emulsified aqueous resins or polymers are stabilized in a resin/polymer emulsion system containing the fluid characterized by the extreme chemical environment.

2. The method of claim 1, wherein the stability-incompatible pH and/or ionic strength of the extreme chemical environment is characterized by any ionic strength or any pH that is capable of causing the emulsified aqueous resins or polymers to destabilize.

3. The method of any one of claims 1 and 2, wherein the fluid characterized by an extreme chemical environment is a coating medium or an industrial fluid comprising water as the majority component.

4. The method of any one of claims 1-3, wherein the organic premix comprises industrial film forming fluid, organic additives that are incompatible in the extreme chemical environment, and/or other coating mediums used in industrial applications.

5. The method of any one of claims 1-4, wherein the resin/polymer emulsion system is stabilized for at least 2 years sealed at ambient conditions, for at least 30 days in a sealed oven/heated environment at 60° C., or for at least 30 days in a sealed refrigeration system at 5° C.

6. The method of any one of claims 1-5, wherein the fluid characterized by the extreme chemical environment includes one or more of Cr(VI) Oxide, Cr(III) Nitrate, Cr(III) Phosphate, any other metal used to improve corrosion resistance, common mineral acids, reducing agents, waxes, defoamers, and any other additives.

7. The method of any one of claims 1-6, wherein the extreme chemical environment is further characterized by a pH of lower than about 3 or greater than about 11.

8. The method of any one of claims 1-7, wherein the high HLB surfactant has an HLB value of between about 8 and about 18, between about 9 and 17, between about 10 and 16, between about 11 and 15, or between about 12 and 14.

9. The method of any one of claims 1-8, wherein the high HLB surfactant has an HLB value of at least about 8, of at least about 9, of at least about 10, of at least about 11, of at least about 12, of at least about 13, of at least about 14, of at least about 15, of at least about 16, or of at least about 17.

10. The method of any one of claims 1-9, wherein the high HLB surfactant has an HLB value of about 8, of about 9, of about 10, of about 11, of about 12, of about 13, of about 14, of about 15, of about 16, of about 17, or of about 18.

11. The method of any one of claims 1-10, wherein the fluid characterized by the extreme chemical environment is an acidic passivate.

12. The method of any one of claims 1-11, wherein the composition comprises from about 0.1 wt % to about 15 wt % high HLB surfactant.

13. The method of any one of claims 1-12, wherein the composition comprises from about 0.5 wt % to about 50 wt % resins that have been emulsified in the aqueous fluid.

14. The method of any one of claims 1-13, wherein the high HLB surfactant is added to the organic premix to yield a mixture of organic premix and high HLB surfactant.

15. The method of any one of claims 1-14, wherein the fluid characterized by the extreme chemical environment is added to the mixture of organic premix and high HLB surfactant to yield the composition.

16. The method of any one of claims 1-15, wherein the fluid characterized by the extreme chemical environment is added to the mixture of organic premix and high HLB surfactant in a step-wise fashion.

17. The method of any one of claims 1-16, wherein the fluid characterized by an extreme chemical environment has a high ionic strength and comprises electrolytes that are capable of destabilizing the emulsified aqueous resins or polymers.

18. The method of claim 17, wherein the electrolytes comprise phosphates, nitrates, the salts of nitric acid and phosphoric acid, HEDP, Chromium (III), other passivating metals and combinations thereof.

19. A method for stabilizing one or more emulsified aqueous resins or polymers within a fluid characterized by an extreme chemical environment having a stability-incompatible pH and/or ionic strength for the one or more emulsified aqueous resins or polymers, the method comprising:
combining the one or more emulsified aqueous resins or polymers with a high hydrophobic-lipophilic balance (HLB) surfactant and the fluid characterized by the extreme chemical environment to yield a composition wherein the one or more emulsified aqueous resins or polymers are stabilized in a resin/polymer emulsion system containing the fluid characterized by the extreme chemical environment.

20. The method of claim 19, wherein the stability-incompatible pH and/or ionic strength of the extreme chemical environment is characterized by any ionic strength or any pH that is capable of causing the one or more emulsified aqueous resins or polymers to destabilize.

21. The method of any one of claims 19 and 20, wherein the fluid characterized by an extreme chemical environment is a coating medium or an industrial fluid comprising water as the majority component.

22. The method of any one of claims 19-21, wherein the composition further comprises industrial film forming fluid, organic additives that are incompatible in the extreme chemical environment, and/or other coating mediums used in industrial applications.

23. The method of any one of claims 19-22, wherein the resin/polymer emulsion system is stabilized for at least 2 years sealed at ambient conditions, for at least 30 days in a sealed oven/heated environment at 60° C., or for at least 30 days in a sealed refrigeration system at 5° C.

24. The method of any one of claims 19-23, wherein the fluid characterized by the extreme chemical environment includes one or more of Cr(VI) Oxide, Cr(III) Nitrate, Cr(III) Phosphate, any other metal used to improve corrosion resistance, common mineral acids, reducing agents, waxes, defoamers, and any other additives.

25. The method of any one of claims 19-24, wherein the extreme chemical environment is further characterized by a pH of lower than about 3 or greater than about 11.

26. The method of any one of claims 19-25, wherein the high HLB surfactant has an HLB value of between about 8 and about 18, between about 9 and 17, between about 10 and 16, between about 11 and 15, or between about 12 and 14.

27. The method of any one of claims 19-26, wherein the high HLB surfactant has an HLB value of at least about 8, of at least about 9, of at least about 10, of at least about 11, of at least about 12, of at least about 13, of at least about 14, of at least about 15, of at least about 16, or of at least about 17.

28. The method of any one of claims 19-27, wherein the high HLB surfactant has an HLB value of about 8, of about 9, of about 10, of about 11, of about 12, of about 13, of about 14, of about 15, of about 16, of about 17, or of about 18.29. The method of any one of claims 19-28, wherein the fluid characterized by the extreme chemical environment is an acidic passivate.

30. The method of any one of claims 19-29, wherein the composition comprises from about 0.1 wt % to about 15 wt % high HLB surfactant.

31. The method of any one of claims 19-30, wherein the composition comprises from about 0.5 wt % to about 50 wt % aqueous resins that have been emulsified in water.

32. The method of any one of claims 19-31, wherein the high HLB surfactant is added to the one or more emulsified aqueous resins or polymers to yield a mixture of one or more emulsified aqueous resins or polymers and high HLB surfactant.

33. The method of any one of claims 19-32, wherein the fluid characterized by the extreme chemical environment is added to the mixture of one or more emulsified aqueous resins or polymers and high HLB surfactant to yield the composition.

34. The method of any one of claims 19-33, wherein the fluid characterized by the extreme chemical environment is added to the mixture of one or more emulsified aqueous resins or polymers and high HLB surfactant in a step-wise fashion.

35. The method of any one of claims 19-34, wherein the fluid characterized by an extreme chemical environment has a high ionic strength and comprises electrolytes that are capable of destabilizing the emulsified aqueous resins or polymers.

36. The method of claim 35, wherein the electrolytes comprise phosphates, nitrates, the salts of nitric acid and phosphoric acid, HEDP, Chromium (III), other passivating metals and combinations thereof.

37. A stabilized resin/polymer emulsion system produced according to the method of any one of claims 1-18.

38. A stabilized resin/polymer emulsion system produced according to the method of any one of claims 19-36.

39. A stabilized resin and/or polymer emulsion comprising:
an aqueous resin and/or polymer emulsion;
a fluid characterized by an extreme chemical environment having a stability-incompatible pH and/or ionic strength for the aqueous resin and/or polymer emulsion;
a high hydrophobic-lipophilic balance (HLB) surfactant; and
an acidic passivate.

40. The stabilized resin and/or polymer emulsion of claim 39, wherein the stability-incompatible pH and/or ionic strength of the extreme chemical environment is characterized by any ionic strength or any pH that is capable of causing the aqueous resin and/or polymer emulsion to destabilize.

41. The stabilized resin and/or polymer emulsion of any one of claims 39 and 40, wherein the fluid characterized by an extreme chemical environment is a coating medium or an industrial fluid comprising water as the majority component.

42. The stabilized resin and/or polymer emulsion of any one of claims 39-41, wherein the aqueous resin and/or polymer emulsion comprises industrial film forming fluid, organic additives that are incompatible in the extreme chemical environment, and/or other coating mediums used in industrial applications.

43. The stabilized resin and/or polymer emulsion of any one of claims 39-42, wherein the resin/polymer emulsion is stabilized for at least 2 years sealed at ambient conditions, for at least 30 days in a sealed oven/heated environment at 60° C., or for at least 30 days in a sealed refrigeration system at 5° C.

44. The stabilized resin and/or polymer emulsion of any one of claims 39-43, wherein the fluid characterized by the extreme chemical environment includes one or more of Cr(VI) Oxide, Cr(III) Nitrate, Cr(III) Phosphate, any other metal used to improve corrosion resistance, common mineral acids, reducing agents, waxes, defoamers, and any other additives.

45. The stabilized resin and/or polymer emulsion of any one of claims 39-44, wherein the extreme chemical environment is further characterized by a pH of lower than about 3 or greater than about 11.

46. The stabilized resin and/or polymer emulsion of any one of claims 39-45, wherein the high HLB surfactant has an HLB value of between about 8 and about 18, between about 9 and 17, between about 10 and 16, between about 11 and 15, or between about 12 and 14.

47. The stabilized resin and/or polymer emulsion of any one of claims 39-46, wherein the high HLB surfactant has an HLB value of at least about 8, of at least about 9, of at least about 10, of at least about 11, of at least about 12, of at least about 13, of at least about 14, of at least about 15, of at least about 16, or of at least about 17.

48. The stabilized resin and/or polymer emulsion of any one of claims 39-47, wherein the high HLB surfactant has an HLB value of about 8, of about 9, of about 10, of about 11, of about 12, of about 13, of about 14, of about 15, of about 16, of about 17, or of about 18.

49. The stabilized resin and/or polymer emulsion of any one of claims 39-48, wherein the fluid characterized by the extreme chemical environment is an acidic passivate.

50. The stabilized resin and/or polymer emulsion of claim 49, wherein the acidic passivate has a pH of less than about 3.

51. The stabilized resin and/or polymer emulsion of any one of claims 39-50, wherein the composition comprises from about 0.1 wt % to about 15 wt % high HLB surfactant, or about 1 wt % to about 14 wt % high HLB surfactant, or about 2 wt % to about 13 wt % high HLB surfactant, or about 3 wt % to about 12 wt % high HLB surfactant, or about 4 wt % to about 11 wt % high HLB surfactant, or about 5 wt % to about 10 wt % high HLB surfactant, or about 6 wt % to about 9 wt % high HLB surfactant, or about 7 wt % to about 8 wt % high HLB surfactant.

52. The stabilized resin and/or polymer emulsion of claim 51, comprising: about 0.4 wt % high HLB surfactants, about 1 wt % high HLB surfactants, about 2 wt % high HLB surfactants, about 3 wt % high HLB surfactants, about 4 wt % high HLB surfactants, about 5 wt % high HLB surfactants, about 6 wt % high HLB surfactants, about 7 wt % high HLB surfactants, about 8 wt % high HLB surfactants, about 9 wt % high HLB surfactants, about 10 wt % high HLB surfactants, about 11 wt % high HLB surfactants, about 12 wt % high HLB surfactants, about 13 wt % high HLB surfactants, about 14 wt % high HLB surfactants, or about 15 wt % high HLB surfactants.

53. The stabilized resin and/or polymer emulsion of any one of claims 39-52, wherein the composition comprises from about 0.5 wt % to about 50 wt % aqueous resin and/or polymer emulsion, or about 1 wt % to about 40 wt % aqueous resin and/or polymer emulsion, or about 2 wt % to about 30 wt % aqueous resin and/or polymer emulsion, or about 3 wt % to about 20 wt % aqueous resin and/or polymer emulsion, or about 4 wt % to about 10 wt % aqueous resin and/or polymer emulsion, or about 5 wt % to about 9 wt % aqueous resin and/or polymer emulsion, or about 6 wt % to about 8 wt % aqueous resin and/or polymer emulsion.

54. The stabilized resin and/or polymer emulsion of any one of claims 39-53, wherein the composition comprises about 0.5 wt % aqueous resin and/or polymer emulsion, 1 wt % aqueous resin and/or polymer emulsion, about 2 wt % aqueous resin and/or polymer emulsion, about 3 wt % aqueous resin and/or polymer emulsion, about 4 wt % aqueous resin and/or polymer emulsion, about 5 wt % aqueous resin and/or polymer emulsion, about 6 wt % aqueous resin and/or polymer emulsion, about 7 wt % aqueous resin and/or polymer emulsion, about 8 wt % aqueous resin and/or polymer emulsion, about 9 wt % aqueous resin and/or polymer emulsion, about 10 wt % aqueous resin and/or polymer emulsion, about 20 wt % aqueous resin and/or polymer emulsion, about 30 wt % aqueous resin and/or polymer emulsion, about 40 wt % aqueous resin and/or polymer emulsion, or about 50 wt % aqueous resin and/or polymer emulsion.

55. The stabilized resin and/or polymer emulsion of any one of claims 39-54, wherein the fluid characterized by an extreme chemical environment has a high ionic strength and comprises electrolytes that are capable of destabilizing the aqueous resin and/or polymer emulsion.

56. The stabilized resin and/or polymer emulsion of claim 55, wherein the electrolytes comprise phosphates, nitrates, the salts of nitric acid and phosphoric acid, HEDP, Chromium (III), other passivating metals and combinations thereof.

57. The stabilized resin and/or polymer emulsion of any one of claims 39-56, comprising from about 0 wt % to about 85 wt % water, or from about 5 wt % to about 80 wt % water, from about 10 wt % to about 75 wt % water, from about 15 wt % to about 70 wt % water, from about 20 wt % to about 65 wt % water, from about 25 wt % to about 60 wt % water, from about 30 wt % to about 55 wt % water, from about 35 wt % to about 50 wt % water, or from about 40 wt % to about 45 wt % water.

58. The stabilized resin and/or polymer emulsion of claim 57, wherein the water is DI water.

59. The stabilized resin and/or polymer emulsion of any one of claims 39-58, comprising from about 1 wt % to about 20 wt % additives, or from about 5 wt % to about 16 wt % additives, or from about 9 wt % to about 12 wt % additives.

60. The stabilized resin and/or polymer emulsion of claim 59, wherein the additives include one or more of wax, defoamer, rheology modifiers, pigments, fillers.

61. The stabilized resin and/or polymer emulsion of any one of claims 39-60, comprising from about 1 wt % to about 85 wt % fluid characterized by an extreme chemical environment, or from about 5 wt % to about 80 wt % fluid characterized by an extreme chemical environment, from about 10 wt % to about 75 wt % fluid characterized by an extreme chemical environment, from about 15 wt % to about 70 wt % fluid characterized by an extreme chemical environment, from about 20 wt % to about 65 wt % fluid characterized by an extreme chemical environment, from about 25 wt % to about 60 wt % fluid characterized by an extreme chemical environment, from about 30 wt % to about 55 wt % fluid characterized by an extreme chemical environment, from about 35 wt % to about 50 wt % fluid characterized by an extreme chemical environment, or from about 40 wt % to about 45 wt % fluid characterized by an extreme chemical environment.

62. A stabilized resin and/or polymer emulsion comprising:
an aqueous resin and/or polymer emulsion;
a fluid characterized by an extreme chemical environment having a stability-incompatible pH and/or ionic strength for the aqueous resin and/or polymer emulsion; and
a high hydrophobic-lipophilic balance (HLB) surfactant.

63. The stabilized resin and/or polymer emulsion of claim 62, wherein the stability-incompatible pH and/or ionic strength of the extreme chemical environment is characterized by any ionic strength or any pH that is capable of causing the aqueous resin and/or polymer emulsion to destabilize.

64. The stabilized resin and/or polymer emulsion of any one of claims 62 and 63, wherein the fluid characterized by an extreme chemical environment is a coating medium or an industrial fluid comprising water as the majority component.

65. The stabilized resin and/or polymer emulsion of any one of claims 62-64, wherein the aqueous resin and/or polymer emulsion comprises industrial film forming fluid, organic additives that are incompatible in the extreme chemical environment, and/or other coating mediums used in industrial applications.

66. The stabilized resin and/or polymer emulsion of any one of claims 62-65, wherein the resin/polymer emulsion is stabilized for at least 2 years sealed at ambient conditions, for at least 30 days in a sealed oven/heated environment at 60° C., or for at least 30 days in a sealed refrigeration system at 5° C.

67. The stabilized resin and/or polymer emulsion of any one of claims 62-66, wherein the fluid characterized by the extreme chemical environment includes one or more of Cr(VI) Oxide, Cr(III) Nitrate, Cr(III) Phosphate, any other metal used to improve corrosion resistance, common mineral acids, reducing agents, waxes, defoamers, and any other additives.

68. The stabilized resin and/or polymer emulsion of any one of claims 62-67, wherein the extreme chemical environment is further characterized by a pH of lower than about 3 or greater than about 11.

69. The stabilized resin and/or polymer emulsion of any one of claims 62-68, wherein the high HLB surfactant has an HLB value of between about 8 and about 18, between about 9 and 17, between about 10 and 16, between about 11 and 15, or between about 12 and 14.

70. The stabilized resin and/or polymer emulsion of any one of claims 62-69, wherein the high HLB surfactant has an HLB value of at least about 8, of at least about 9, of at least about 10, of at least about 11, of at least about 12, of at least about 13, of at least about 14, of at least about 15, of at least about 16, or of at least about 17.

71. The stabilized resin and/or polymer emulsion of any one of claims 62-70, wherein the high HLB surfactant has an HLB value of about 8, of about 9, of about 10, of about 11, of about 12, of about 13, of about 14, of about 15, of about 16, of about 17, or of about 18.

72. The stabilized resin and/or polymer emulsion of any one of claims 62-71, wherein the fluid characterized by the extreme chemical environment is an acidic passivate.

73. The stabilized resin and/or polymer emulsion of claim 72, wherein the acidic passivate has a pH of less than about 3.

74. The stabilized resin and/or polymer emulsion of any one of claims 62-73, wherein the composition comprises from about 0.1 wt % to about 15 wt % high HLB surfactant, or about 1 wt % to about 14 wt % high HLB surfactant, or about 2 wt % to about 13 wt % high HLB surfactant, or about 3 wt % to about 12 wt % high HLB surfactant, or about 4 wt % to about 11 wt % high HLB surfactant, or about 5 wt % to about 10 wt % high HLB surfactant, or about 6 wt % to about 9 wt % high HLB surfactant, or about 7 wt % to about 8 wt % high HLB surfactant.

75. The stabilized resin and/or polymer emulsion of claim 74, comprising: about 0.4 wt % high HLB surfactants, about 1 wt % high HLB surfactants, about 2 wt % high HLB surfactants, about 3 wt % high HLB surfactants, about 4 wt % high HLB surfactants, about 5 wt % high HLB surfactants, about 6 wt % high HLB surfactants, about 7 wt % high HLB surfactants, about 8 wt % high HLB surfactants, about 9 wt % high HLB surfactants, about 10 wt % high HLB surfactants, about 11 wt % high HLB surfactants, about 12 wt % high HLB surfactants, about 13 wt % high HLB surfactants, about 14 wt % high HLB surfactants, or about 15 wt % high HLB surfactants.

76. The stabilized resin and/or polymer emulsion of any one of claims 62-75, wherein the composition comprises from about 0.5 wt % to about 50 wt % aqueous resin and/or polymer emulsion, or about 1 wt % to about 40 wt % aqueous resin and/or polymer emulsion, or about 2 wt % to about 30 wt % aqueous resin and/or polymer emulsion, or about 3 wt % to about 20 wt % aqueous resin and/or polymer emulsion, or about 4 wt % to about 10 wt % aqueous resin and/or polymer emulsion, or about 5 wt % to about 9 wt % aqueous resin and/or polymer emulsion, or about 6 wt % to about 8 wt % aqueous resin and/or polymer emulsion.

77. The stabilized resin and/or polymer emulsion of any one of claims 62-76, wherein the composition comprises about 0.5 wt % aqueous resin and/or polymer emulsion, 1 wt % aqueous resin and/or polymer emulsion, about 2 wt % aqueous resin and/or polymer emulsion, about 3 wt % aqueous resin and/or polymer emulsion, about 4 wt % aqueous resin and/or polymer emulsion, about 5 wt % aqueous resin and/or polymer emulsion, about 6 wt % aqueous resin and/or polymer emulsion, about 7 wt % aqueous resin and/or polymer emulsion, about 8 wt % aqueous resin and/or polymer emulsion, about 9 wt % aqueous resin and/or polymer emulsion, about 10 wt % aqueous resin and/or polymer emulsion, about 20 wt % aqueous resin and/or polymer emulsion, about 30 wt % aqueous resin and/or polymer emulsion, about 40 wt % aqueous resin and/or polymer emulsion, or about 50 wt % aqueous resin and/or polymer emulsion.

78. The stabilized resin and/or polymer emulsion of any one of claims 62-77, wherein the fluid characterized by an extreme chemical environment has a high ionic strength and comprises electrolytes that are capable of destabilizing the aqueous resin and/or polymer emulsion.

79. The stabilized resin and/or polymer emulsion of claim 78, wherein the electrolytes comprise phosphates, nitrates, the salts of nitric acid and phosphoric acid, HEDP, Chromium (III), other passivating metals and combinations thereof.

80. The stabilized resin and/or polymer emulsion of any one of claims 62-79, comprising from about 0 wt % to about 85 wt % water, or from about 5 wt % to about 80 wt % water, from about 10 wt % to about 75 wt % water, from about 15 wt % to about 70 wt % water, from about 20 wt % to about 65 wt % water, from about 25 wt % to about 60 wt % water, from about 30 wt % to about 55 wt % water, from about 35 wt % to about 50 wt % water, or from about 40 wt % to about 45 wt % water.

81. The stabilized resin and/or polymer emulsion of claim 80, wherein the water is DI water.

82. The stabilized resin and/or polymer emulsion of any one of claims 62-81, comprising from about 1 wt % to about 20 wt % additives, or from about 5 wt % to about 16 wt % additives, or from about 9 wt % to about 12 wt % additives.

83. The stabilized resin and/or polymer emulsion of claim 82, wherein the additives include one or more of wax, defoamer, rheology modifiers, pigments, fillers.

84. The stabilized resin and/or polymer emulsion of any one of claims 62-83, comprising from about 1 wt % to about 85 wt % fluid characterized by an extreme chemical environment, or from about 5 wt % to about 80 wt % fluid characterized by an extreme chemical environment, from about 10 wt % to about 75 wt % fluid characterized by an extreme chemical environment, from about 15 wt % to about 70 wt % fluid characterized by an extreme chemical environment, from about 20 wt % to about 65 wt % fluid characterized by an extreme chemical environment, from about 25 wt % to about 60 wt % fluid characterized by an extreme chemical environment, from about 30 wt % to about 55 wt % fluid characterized by an extreme chemical environment, from about 35 wt % to about 50 wt % fluid characterized by an extreme chemical environment, or from about 40 wt % to about 45 wt % fluid characterized by an extreme chemical environment.

85. A stabilized resin and/or polymer emulsion comprising:
an organic premix comprising an aqueous fluid and at least one resin and/or polymer emulsion;
a fluid characterized by an extreme chemical environment having a stability-incompatible pH and/or ionic strength for the emulsified aqueous resin and/or polymer emulsion; and
a high hydrophobic-lipophilic balance (HLB) surfactant.

86. The stabilized resin and/or polymer emulsion of claim 85 comprising from about 15 wt % to about 95 wt % organic premix, or from about 20 wt % to about 90 wt % organic premix, or from about 25 wt % to about 85 wt % organic premix, or about 30 wt % to about 80 wt % organic premix, or about 35 wt % to about 75 wt % organic premix, or about 40 wt % to about 70 wt % organic premix.

87. The stabilized resin and/or polymer emulsion of claim 85 or claim 86, wherein the stability-incompatible pH and/or ionic strength of the extreme chemical environment is characterized by any ionic strength or any pH that is capable of causing the aqueous resin and/or polymer emulsion to destabilize.

88. The stabilized resin and/or polymer emulsion of any one of claims 85-87, wherein the fluid characterized by an extreme chemical environment is a coating medium or an industrial fluid comprising water as the majority component.

89. The stabilized resin and/or polymer emulsion of any one of claims 85-88, wherein the organic premix comprises industrial film forming fluid, organic additives that are incompatible in the extreme chemical environment, and/or other coating mediums used in industrial applications.

90. The stabilized resin and/or polymer emulsion of any one of claims 85-89, wherein the resin/polymer emulsion is stabilized for at least 2 years sealed at ambient conditions, for at least 30 days in a sealed oven/heated environment at 60° C., or for at least 30 days in a sealed refrigeration system at 5° C.

91. The stabilized resin and/or polymer emulsion of any one of claims 85-90, wherein the fluid characterized by the extreme chemical environment includes one or more of Cr(VI) Oxide, Cr(III) Nitrate, Cr(III) Phosphate, any other metal used to improve corrosion resistance, common mineral acids, reducing agents, waxes, defoamers, and any other additives.

92. The stabilized resin and/or polymer emulsion of any one of claims 85-91, wherein the extreme chemical environment is further characterized by a pH of lower than about 3 or greater than about 11.

93. The stabilized resin and/or polymer emulsion of any one of claims 85-92, wherein the high HLB surfactant has an HLB value of between about 8 and about 18, between about 9 and 17, between about 10 and 16, between about 11 and 15, or between about 12 and 14.

94. The stabilized resin and/or polymer emulsion of any one of claims 85-93, wherein the high HLB surfactant has an HLB value of at least about 8, of at least about 9, of at least about 10, of at least about 11, of at least about 12, of at least about 13, of at least about 14, of at least about 15, of at least about 16, or of at least about 17.

95. The stabilized resin and/or polymer emulsion of any one of claims 85-94, wherein the high HLB surfactant has an HLB value of about 8, of about 9, of about 10, of about 11, of about 12, of about 13, of about 14, of about 15, of about 16, of about 17, or of about 18.

96. The stabilized resin and/or polymer emulsion of any one of claims 85-95, wherein the fluid characterized by the extreme chemical environment is an acidic passivate.

97. The stabilized resin and/or polymer emulsion of claim 96, wherein the acidic passivate has a pH of less than about 3.

98. The stabilized resin and/or polymer emulsion of any one of claims 85-97, wherein the composition comprises from about 0.1 wt % to about 15 wt % high HLB surfactant, or about 1 wt % to about 14 wt % high HLB surfactant, or about 2 wt % to about 13 wt % high HLB surfactant, or about 3 wt % to about 12 wt % high HLB surfactant, or about 4 wt % to about 11 wt % high HLB surfactant, or about 5 wt % to about 10 wt % high HLB surfactant, or about 6 wt % to about 9 wt % high HLB surfactant, or about 7 wt % to about 8 wt % high HLB surfactant.

99. The stabilized resin and/or polymer emulsion of claim 98, comprising: about 0.4 wt % high HLB surfactants, about 1 wt % high HLB surfactants, about 2 wt % high HLB surfactants, about 3 wt % high HLB surfactants, about 4 wt % high HLB surfactants, about 5 wt % high HLB surfactants, about 6 wt % high HLB surfactants, about 7 wt % high HLB surfactants, about 8 wt % high HLB surfactants, about 9 wt % high HLB surfactants, about 10 wt % high HLB surfactants, about 11 wt % high HLB surfactants, about 12 wt % high HLB surfactants, about 13 wt % high HLB surfactants, about 14 wt % high HLB surfactants, or about 15 wt % high HLB surfactants.

100. The stabilized resin and/or polymer emulsion of any one of claims 85-99, wherein the composition comprises from about 0.5 wt % to about 50 wt % aqueous resin and/or polymer emulsion, or about 1 wt % to about 40 wt % aqueous resin and/or polymer emulsion, or about 2 wt % to about 30 wt % aqueous resin and/or polymer emulsion, or about 3 wt % to about 20 wt % aqueous resin and/or polymer emulsion, or about 4 wt % to about 10 wt % aqueous resin and/or polymer emulsion, or about 5 wt % to about 9 wt % aqueous resin and/or polymer emulsion, or about 6 wt % to about 8 wt % aqueous resin and/or polymer emulsion.

101. The stabilized resin and/or polymer emulsion of any one of claims 85-100, wherein the composition comprises about 0.5 wt % aqueous resin and/or polymer emulsion, 1 wt % aqueous resin and/or polymer emulsion, about 2 wt % aqueous resin and/or polymer emulsion, about 3 wt % aqueous resin and/or polymer emulsion, about 4 wt % aqueous resin and/or polymer emulsion, about 5 wt % aqueous resin and/or polymer emulsion, about 6 wt % aqueous resin and/or polymer emulsion, about 7 wt % aqueous resin and/or polymer emulsion, about 8 wt % aqueous resin and/or polymer emulsion, about 9 wt % aqueous resin and/or polymer emulsion, about 10 wt % aqueous resin and/or polymer emulsion, about 20 wt % aqueous resin and/or polymer emulsion, about 30 wt % aqueous resin and/or polymer emulsion, about 40 wt % aqueous resin and/or polymer emulsion, or about 50 wt % aqueous resin and/or polymer emulsion.

102. The stabilized resin and/or polymer emulsion of any one of claims 85-101, wherein the fluid characterized by an extreme chemical environment has a high ionic strength and comprises electrolytes that are capable of destabilizing the aqueous resin and/or polymer emulsion.

103. The stabilized resin and/or polymer emulsion of claim 102, wherein the electrolytes comprise phosphates, nitrates, the salts of nitric acid and phosphoric acid, HEDP, Chromium (III), other passivating metals and combinations thereof.

104. The stabilized resin and/or polymer emulsion of any one of claims 85-103, comprising from about 0 wt % to about 85 wt % water, or from about 5 wt % to about 80 wt % water, from about 10 wt % to about 75 wt % water, from about 15 wt % to about 70 wt % water, from about 20 wt % to about 65 wt % water, from about 25 wt % to about 60 wt % water, from about 30 wt % to about 55 wt % water, from about 35 wt % to about 50 wt % water, or from about 40 wt % to about 45 wt % water.

105. The stabilized resin and/or polymer emulsion of claim 104, wherein the water is DI water.

106. The stabilized resin and/or polymer emulsion of any one of claims 85-105, comprising from about 1 wt % to about 20 wt % additives, or from about 5 wt % to about 16 wt % additives, or from about 9 wt % to about 12 wt % additives.

107. The stabilized resin and/or polymer emulsion of claim 106, wherein the additives include one or more of wax, defoamer, rheology modifiers, pigments, fillers.

108. The stabilized resin and/or polymer emulsion of any one of claims 85-107, comprising from about 1 wt % to about 85 wt % fluid characterized by an extreme chemical environment, or from about 5 wt % to about 80 wt % fluid characterized by an extreme chemical environment, from about 10 wt % to about 75 wt % fluid characterized by an extreme chemical environment, from about 15 wt % to about 70 wt % fluid characterized by an extreme chemical environment, from about 20 wt % to about 65 wt % fluid characterized by an extreme chemical environment, from about 25 wt % to about 60 wt % fluid characterized by an extreme chemical environment, from about 30 wt % to about 55 wt % fluid characterized by an extreme chemical environment, from about 35 wt % to about 50 wt % fluid characterized by an extreme chemical environment, or from about 40 wt % to about 45 wt % fluid characterized by an extreme chemical environment.

109. The stabilized resin and/or polymer emulsion of claim 85, wherein the aqueous fluid of the organic premix may also comprise industrial passivation fluid that is already stable with the emulsified aqueous resin.

110. A stabilized resin and/or polymer emulsion comprising:
an aqueous resin and/or polymer emulsion;
an acidic passivate; and
a high hydrophobic-lipophilic balance (HLB) surfactant.

111. The method according to any one of claims 1-18, wherein the high HLB surfactant is a nonionic ethoxylated surfactant.

112. The method according to any one of claims 19-36, wherein the high HLB surfactant is a nonionic ethoxylated surfactant.

113. The stabilized resin/polymer emulsion system of claim 37, wherein the high HLB surfactant is a nonionic ethoxylate surfactant.

114. The stabilized resin/polymer emulsion system of claim 38, wherein the high HLB surfactant is a nonionic ethoxylate surfactant.

115. The stabilized resin and/or polymer emulsion of any one of claims 39-61, wherein the high HLB surfactant is a nonionic ethoxylated surfactant.

116. The stabilized resin and/or polymer emulsion of any one of claims 62-84, wherein the high HLB surfactant is a nonionic ethoxylated surfactant.

117. The stabilized resin and/or polymer emulsion of any one of claims 85-109, wherein the high HLB surfactant is a nonionic ethoxylated surfactant.

118. The stabilized resin and/or polymer emulsion of claim 110, wherein the high HLB surfactant is a nonionic ethoxylated surfactant.

119. The method according to any one of claims 1-18 and 111, wherein the high HLB surfactant is a non-reactive surfactant.

120. The method according to any one of claims 19-36 and 112, wherein the high HLB surfactant is a non-reactive surfactant.

121. The stabilized resin/polymer emulsion system of one of claim 37 and claim 113, wherein the high HLB surfactant is a non-reactive surfactant.

122. The stabilized resin/polymer emulsion system of one of claim 38 and claim 114, wherein the high HLB surfactant is a non-reactive surfactant.

123. The stabilized resin and/or polymer emulsion of any one of claims 39-61 and 115, wherein the high HLB surfactant is a non-reactive surfactant.

124. The stabilized resin and/or polymer emulsion of any one of claims 62-84 and 116, wherein the high HLB surfactant is a non-reactive surfactant.

125. The stabilized resin and/or polymer emulsion of any one of claims 85-109 and 117, wherein the high HLB surfactant is a non-reactive surfactant.

126. The stabilized resin and/or polymer emulsion of one of claim 110 and claim 118, wherein the high HLB surfactant is a non-reactive surfactant.
